(19) United States
(12) Patent Application Publication
(10) Pub. No.: US 2012/0270175 A1
(43) Pub. Date: Oct. 25, 2012

(54) SELF-LIGATING BRACKET FOR ORTHODONTIC TREATMENT

(75) Inventors: Scott A. Huge, Cumming, GA (US); Steve A. Franseen, Broomfield, CO (US)

(73) Assignee: Specialty Appliance Works, Inc., Cumming, GA (US)

(21) Appl. No.: 13/450,266

(22) Filed: Apr. 18, 2012

Related U.S. Application Data
(60) Provisional application No. 61/477,327, filed on Apr. 20, 2011.

(51) Int. Cl. A61C 7/34

(52) U.S. Cl. 433/14

(57) ABSTRACT

A self-ligating orthodontic bracket assembly has a bracket with an archwire slot extending in a mesial-distal direction for receiving an archwire; a vertical slot extending into the bracket to intersect the archwire slot; and a retentive boss in the vertical slot. A retentive pin slides in the vertical slot between an open position and a closed position. The pin has two parallel legs separated by a space, and a lower cross member extending between the legs. The cross member contacts the retentive boss in the open position to retain the pin in the vertical slot. Camming surfaces on the legs slidably engage the vertical slot to hold the pin in the closed position.

### RELATED APPLICATION

The present application is based on and claims priority to the Applicants' U.S. Provisional Patent Application 61/477,327, entitled “Self-Ligating Bracket For Orthodontic Treatment,” filed on Apr. 20, 2011.

### BACKGROUND OF THE INVENTION

1. Field of the Invention

The present invention relates generally to the field of orthodontic appliances. More specifically, the present invention discloses a self-ligating orthodontic bracket.

2. Background of the Invention

The orthodontic specialty of dentistry involves the straightening of a patient's teeth and establishing a balance between the upper and lower jaws for ideal function. Even though many modes of achieving such correction have been developed, the mainstay of orthodontic treatment remains essentially unchanged. That is, the general steps involving the attachment of orthodontic brackets to a range of teeth to be treated and joining them together in a unified force system through the use of an archwire remain largely unchanged. An archwire is captured by each of the brackets. In response to the spring properties of a deflected archwire, energy stored in the archwire is slowly dissipated through the brackets, to the crown and roots of the teeth. As these gentle but continuous forces are applied, an osteogenic response is elicited in the bone supporting the roots of the teeth allowing the tooth's root to desirably reposition through the supporting bone.

Regarding the means of capturing the archwire in the bracket, the traditional method has involved the tying-in or ligation of the archwire into position within a bracket using a small diameter, fully-annealed stainless steel ligature wire. FIG. 1 is a depiction of a conventional orthodontic bracket 66 with a section of the archwire 65 positioned within the bracket 66 and secured with a ligature wire 67. FIG. 1 illustrates the elements of the tying-in process where the ligature wire 67 is twisted, thereby tightly capturing the archwire 65. Once twisted, the excess portions of the twisted section 64 of the ligature wire 67 are cut off and discarded. The remaining twisted section 64 is tucked under the tie wings of the bracket 66 to avoid laceration of the adjacent soft tissues by the sharp cut ends.

As can be appreciated, all of the ligation steps, when combined and repeated for all of the teeth being treated involve a considerable amount of time and skillful concentration on the part of the practitioner in order to accomplish. Adding to this challenge, ligation must be performed precisely, otherwise the desired corrective forces may not be transferred adequately to the roots of the teeth and supporting bone. Further, there is a potential for injury to the tongue, lips and cheeks if the ligature wire 67 is not tucked safely under the tie wings. In recent years, ligature wires, after being removed from the mouth have been classified as “sharps,” meaning that specific regulatory-defined procedures for handling and disposal are required.

The traditional use of ligature wires and the associated time, expense and cost have been seen as a constraint to the efficiency of orthodontic practices. The need for improved methods for ligation has prompted much innovation. For example, elastomeric ligatures were developed in the late 1970's. Elastomeric ligatures are injection molded from biocompatible rubber-like urethane resins. Elastomeric ligatures are formed in the shape of a torus and can present with any combination of cross-sectional diameter and toroidal diameter required to fit a range of narrow-to-wide brackets. The man-made elastomeric resins are generally slightly stiffer/harder than the familiar natural latex “rubber bands” used in orthodontics

Typically, a patient's treatment plan will call for a progressive series of archwires that are removed and replaced multiple times during treatment. For each archwire change, all of the brackets must be individually ligated. Even though today, both steel ligature wire and elastomeric ligatures have applications in orthodontics, the routine step of ligation itself has remained an obstacle to efficiency, with a large portion of the total time a patient must spend in the orthodontist's chair being relegated to ligation.

The history of innovation has been driven by the need to avoid or reduce the many difficulties associated with ligation. After all, conventional ligation requires additional materials, special instruments and again, much time and concentration on the part of the practitioner and his or her staff. In recent times, as orthodontic practices modernized and began to treat larger numbers of patients, a solution was clearly needed.

Simply stated, orthodontists needed a stand-alone bracket, capable of accepting, and then retaining an archwire. A self-ligating bracket was seen as the solution. Self-ligating bracket designs first appeared in the late 1920's. The design intent was to include features within the bracket itself to capture the archwire within the archwire slot without the need for any additional materials or steps other than perhaps manipulating the integral self-ligation structures to close or open the bracket. For example, the prior art in the field of self-ligating brackets includes U.S. Pat. No. 2,011,575 (Ford), U.S. Pat. No. 4,712,999 (Rosenberg), and U.S. Pat. No. 6,485,299 (Wildman).

Self-ligating brackets tend to be more complex, and can involve sliding or hinged retention clips, pins, springs, keepers, latches, detents and the like. Compared to conventional orthodontic brackets, the basic bracket body of a self-ligating bracket is required to have additional, non-traditional features. Such features co-work with various caps, clips, latches and doors, etc. Those caps, clips and doors themselves likewise must have specific features that in turn co-work with the bracket to function.

Several problems were encountered as early self-ligating brackets were commercialized and began use in treatment. The challenges of manufacturing a bracket body incorporating the additional features required for self-ligation meant that improved manufacturing methods were required for commercial manufacturing. The various caps, clips, latches, hinges and doors themselves often required specific metallurgical treatments and tight manufacturing tolerances. As a result, self-ligating brackets were much more costly than traditional brackets. If manufacturing tolerances were not held, the potential existed for the assembly to come apart, meaning that very small, sometimes sharp components could pose an aspiration or ingestion hazard to the patient. Compared to traditional brackets, self-ligating brackets tended to be significantly larger and more prominent in the mouth, sometimes leading to irritation of soft tissues and patient discomfort. Perhaps the most deleterious aspect of self-ligating brackets was that the step of opening and closing them was very difficult. The tiny mechanisms can be difficult to access, and tartar build-up could render the components immovable.

The present invention avoids the problems mentioned above by providing a secure, easy to open and close, non-complex self-ligating bracket assembly of diminutive size. A retention pin is slidably engaged in a vertical slot in the bracket to retain an archwire in the bracket's archwire slot. The present invention includes means for: (1) retaining the pin in its locked closed position; (2) positioning the pin in its fully-open position; as well as (3) preventing the pin from escaping from the bracket. In addition, the retention pin and vertical slot in the present invention are equally adaptable to both labial and lingual treatment.

### SUMMARY OF THE INVENTION

This invention provides a self-ligating orthodontic bracket assembly having a bracket with an archwire slot extending in a mesial-distal direction for receiving an archwire; a vertical slot extending into the bracket to intersect the archwire slot; and a retentive boss in the vertical slot. A retentive pin slides in the vertical slot between an open position and a closed position. The pin has two parallel legs separated by a space, and a lower cross member extending between the legs. The cross member contacts the retentive boss in the open position to retain the pin in the vertical slot. Camming surfaces on the legs slidably engage the vertical slot to hold the pin in the closed position.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view of a conventional orthodontic bracket 66 with a section of the archwire 65 positioned within the bracket 66 secured by a ligature wire 67.

FIG. 2 is a front view of the retention pin 10.

FIG. 3 is a perspective view of the bracket 20.

FIG. 4 is a cut-away of view of the bracket 20 showing a retention pin 10 inserted into the vertical slot 21 in its closed position.

FIG. 5 is a side cross-sectional view of the bracket 20.

FIG. 6 is a perspective view of a dental instrument 30 being used to raise the retention pin 10 in the bracket 20 to its open position.

FIG. 7 is a perspective view of an assembled bracket 20 and pin 10 in the closed position.

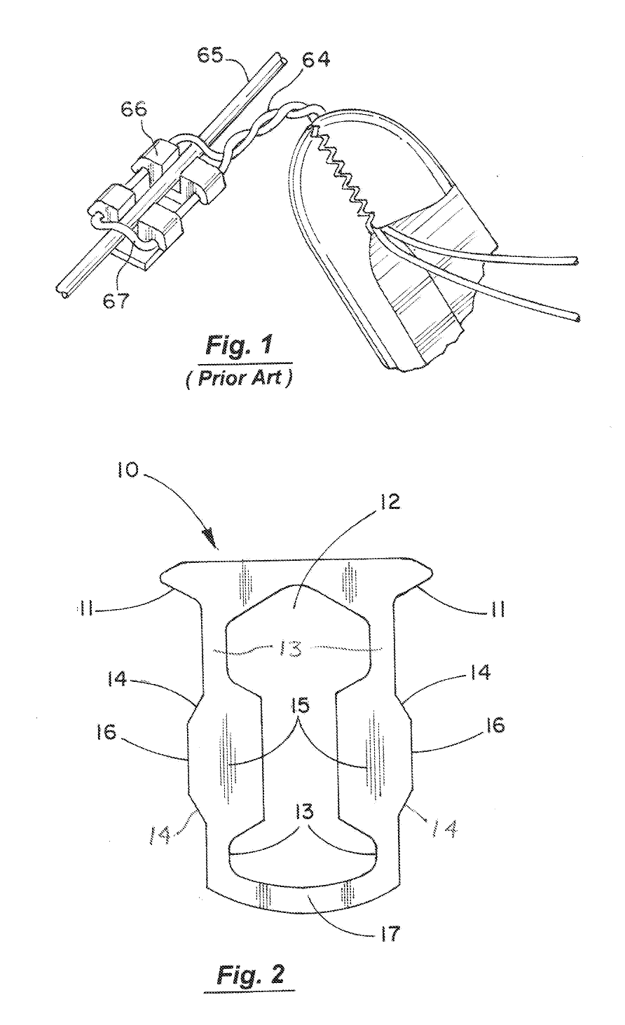

### DETAILED DESCRIPTION OF THE INVENTION

The present invention is comprised of two parts—the bracket 20 and its archwire-retaining pin 10. First, the retentive pin 10 is shown in FIG. 2. The pin 10 is generally rectangular with upper and lower cross members separated by parallel left and right legs that define an interior space within the legs and cross members. Each leg has upper and lower flex sections 13 that are relatively thin, so that the legs can deflect laterally to a small degree in response to lateral forces. The midsection of each leg is a wider retentive plate 15 with a retentive projection 16 extending laterally outward. The transition regions between the flex sections 13 and the retentive plate 15 define angled camming surfaces 14 on the outer lateral edges of the legs that will be discussed below. The retentive pin 10 is preferably formed from 0.008 in. super-elastic nickel-titanium with a ratio of about 50% nickel and 50% titanium by weight. Other metals with suitable super-resilient spring properties are usable. Manufacturing methods include laser cutting or fine blanking.

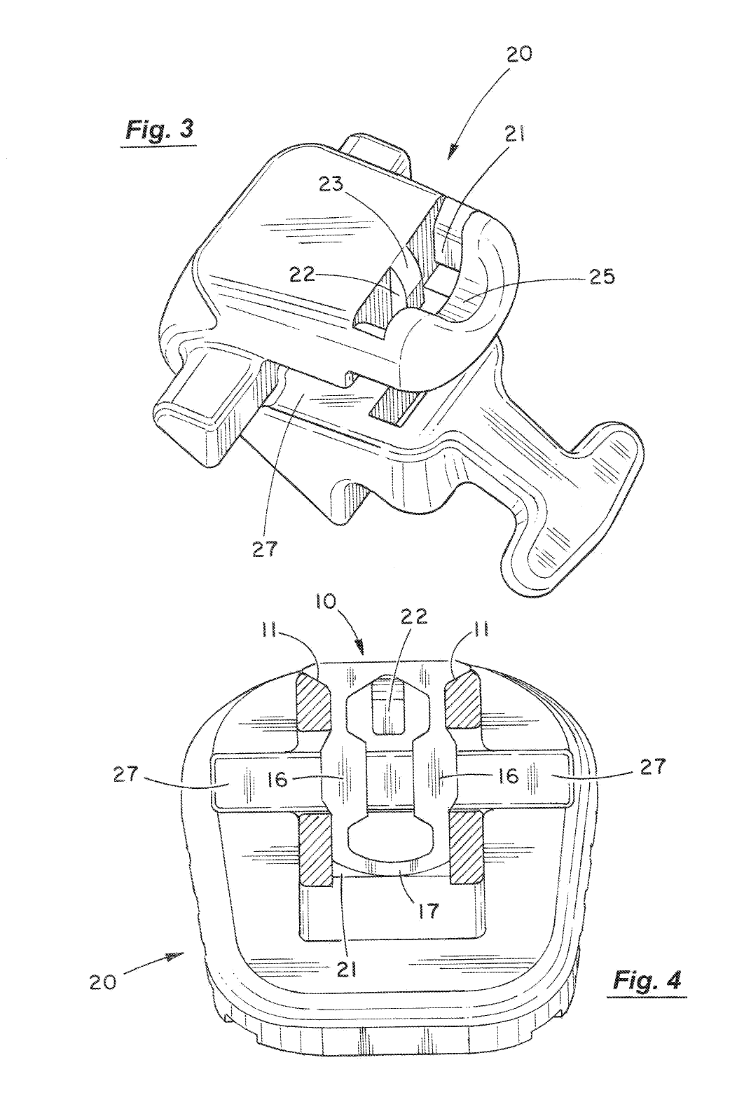

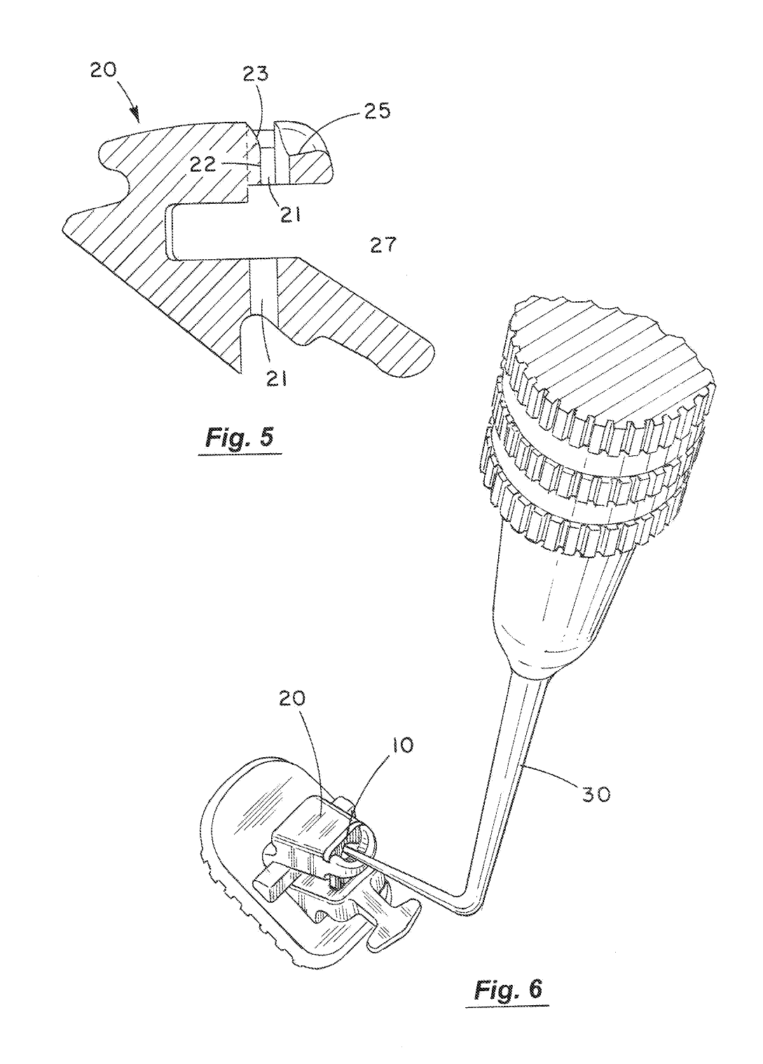

Second, the bracket 20 is illustrated in FIGS. 3 and 5. The bracket 20 has a conventional base 26 for attachment (e.g., by bonding) to the lingual or labial surface of a tooth. An archwire slot 27 extends through the bracket body in a mesial-distal direction to receive an archwire. The bracket 20 also includes a vertical slot 21 designed to receive the pin 10 in sliding engagement. This vertical slot 21 extends through the upper portion of the bracket 20, spans the archwire slot 27 and continues into the lower portion of the bracket 20, as shown in FIG. 5.

The functions of the two parts are described as follows. The lower portion of the pin 10 is initially inserted into the vertical slot 21 in the bracket 20 at the time of manufacture. As the pin 10 is urged downward in the vertical slot 21, it immediately encounters the curved surface 23 of a retentive boss 22 that protrudes into the vertical slot 21 of the bracket 20. This curved surface 23 of the retentive boss 22 deflects the lower cross member 17 of the pin 10, bowing it outward into the vertical slot 21 of the bracket 20. Once the lower cross member 17 of the pin 10 is deflected, the pin 10 can then slide further downward into the vertical slot 21. Importantly, the curvature induced into the lower cross member 17 of the pin 10 by the curved surface 23 of the bracket's retentive boss 22 is released once it passes over the curved surface 23 and the remainder of the retentive boss 22. The cross member 17 then returns to a planar relationship with the rest of the pin 10. Once this occurs, the pin 10 can no longer be removed from the bracket 20 short of destructive cutting. The resulting retention achieves an avoidance of potential hazards associated with the escape of the pin 10 in the mouth.

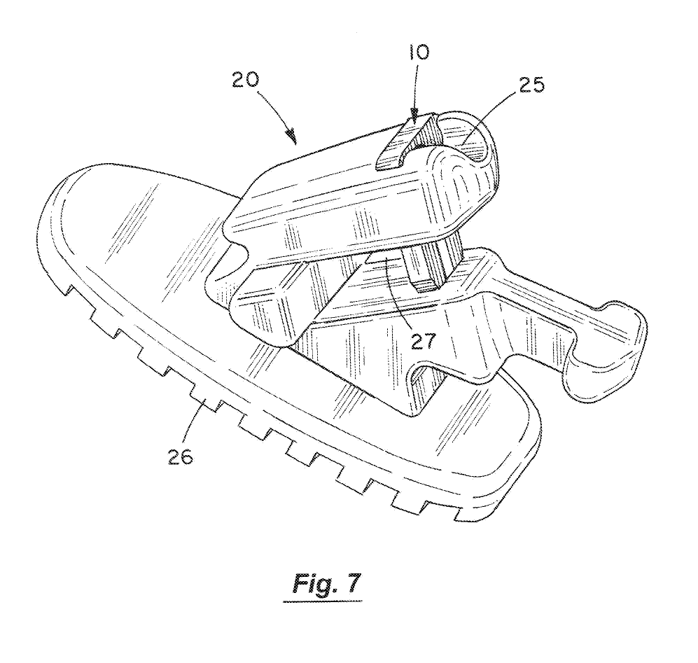

As the pin 10 is inserted further into the vertical slot 21, the two lower camming surfaces 14 of the pin 10 encounter the lateral walls of the vertical slot 21 within the bracket 20. In doing so, the legs of the pin 10 are compressed laterally or inward. In other words, the pin 10 is loaded as a spring into a narrower configuration. The gap between the legs of the pin 10 decrease as the legs are compressed laterally. Further downward movement of the pin 10 results in the retentive projections 16 of the pin 10 springing outward and thereby becoming centered in the archwire slot 27 of the bracket 20. This relationship is shown in the cut-away view in FIG. 4. FIG. 7 shows a perspective view of the assembled pin 10 and bracket 20 in the closed position.

So, with the retentive pin 10 fully inserted in the bracket, each of the four camming surfaces 14 of the pin 10 are “working” and energetically acting to maintain the pin 10 centered between the opposing walls of the archwire slot 27 along the vertical axis. These forces tend to hold the pin 10 in the closed position, thereby retaining an archwire in the archwire slot 27 of the bracket 20. In particular, the camming surfaces 14 of the pin 10 contact the four corner edges created by the intersection of the vertical slot 21 and archwire slot 27 within the bracket 20, as shown in FIG. 4. Additionally, the pin's stop ears 11 are held in contact with the corresponding mating surfaces of the bracket 20. This positive positioning is maintained by the energy stored in the laterally-compressed legs of the pin 10.

Optionally, the lateral walls of the vertical slot 21 in the bracket 20 can include camming surfaces that contact, and are complementary to the camming surfaces 14 of the pin 10. These complementary camming surfaces can be located at the corners defined by the intersection of the archwire slot 27 and the vertical slot 21, similar to the embodiment depicted in FIG. 4, or they could be located elsewhere along the lateral walls of the vertical slot 21.

To open the bracket 20 for removal of an archwire from the archwire slot 27, a dental instrument 30 known as an explorer is inserted as shown in FIG. 6. The instrument tip engages the lift center 12 of the pin 10 and levers the pin 10 upward, using the lift fulcrum surface 25 of the bracket 20 as a fulcrum. As the pin 10 is lifted upward, the lower cross member 17 contacts the lower extent of the retentive boss 22. At this point, the pin 10 cannot move any further in an upward direction. In this open position, the pin 10 is completely clear of the archwire slot 27, allowing for the unimpeded insertion or removal of an archwire. At the full extent of the range of upward travel of the pin 10, the lower cross member 17 of the pin 10 contacts the lower edge of the retentive boss 22 of the bracket to retain the pin 10 in the vertical slot 21 of the bracket 20. In addition, the two lower camming surfaces 14 act against the edges of the vertical slot 21 so that the pin 10 is actively retained in its fully open position.

Other co-working aspects of the present invention include the fact that during the translation of the pin 10 in either an upward or downward direction (i.e., between the open and closed positions), the gap between the legs of the pin 10 is reduced due to the inward compression of the legs of the pin 10 by sliding contact between the camming surfaces 14 and the retentive projections 16 of the pin 10 with the lateral walls of the vertical slot 21. The gap between the legs of pin 10 is reduced as the flex sections 13 are deflected inward by this contact. Although this gap narrows to a width approaching that of the retentive boss 22 on the bracket 20, the gap should remain wide enough to prevent contact or significant friction with the vertical slot 21. On the other hand, the width of the gap between the legs of the pin 10 can be designed so that the sides of the retentive boss 22 serve to create guides for the pin 10 as it slides between the open and closed positions, and thereby prevent the pin 10 from cocking or jamming as it slides.

Another aspect arrived at through exact sizing of the pin 10 predicts that with the pin 10 in its fully closed position, it is flush with the under-tie wing. Otherwise, if the pin 10 were to extend into the underwing ligation area, a ligature (which may be optionally used) could push the pin upward. Similarly, with the pin 10 in its full open position, no portion of the pin 10 extends into the archwire slot 27 aperture, as described earlier.

The overall configuration of the present bracket assembly permits the overall bracket size to be exceedingly small. Unlike other self-ligating bracket designs, it is the presence of the archwire slot itself that provides the positive biasing of the pin 10 into its fully closed position. As such, no other manufacturing critical features such as detents, dimples, latches, or spring catches are required. This thereby again permits the bracket to be desirably small and avoids complexity and reduces manufacturing cost.

Regarding the incorporation of conventional ligation features in the bracket body, those features are far smaller than convention ligation features, and are intended to accommodate only steel ligatures and not the larger elastomeric type. The bracket 20 can also exhibit laterally extending Lewis-type rotation wings, which assist the archwire in imparting corrective forces in terms of rotation. The bracket 20 can be fabricated using standard alloys and manufacturing processes.

Some aspects of the present invention lend themselves to the lingual application. Ergonomically speaking, lingual brackets pose additional challenges for dental professionals such as manipulating self-ligating features on the inner surfaces of the teeth. The central configuration of the present invention lends itself equally to placement on the labial or lingual, but in a lingual role, certain aspects of the present invention are particularly beneficial.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A self-ligating orthodontic bracket assembly comprising:
a bracket having:
(a) an archwire slot extending in a mesial-distal direction for receiving an archwire;
(b) a vertical slot extending into the bracket to intersect the archwire slot; and
(c) a retentive boss in the vertical slot; and
a pin for sliding engagement with the vertical slot between an open position and a closed position, said pin having:
(a) two parallel legs separated by a space, said legs extending across the archwire slot in the closed position to retain an archwire in the archwire slot, and retracting from the archwire slot in the open position to allow insertion of an archwire into the archwire slot;
(b) a lower cross member extending between the legs, said lower cross member contacting the retentive boss in the open position to retain the pin in the vertical slot; and
(c) camming surfaces on the legs slidably engaging the vertical slot to hold the pin in the closed position.

2. The self-ligating orthodontic bracket assembly of claim 1 further comprising an upper cross member extending between the legs to form a substantially rectangular pin.

3. The self-ligating orthodontic bracket assembly of claim 1 wherein at least one of the legs comprises a thin flex section and a wider retentive plate with a retentive projection extending laterally outward from the pin.

4. The self-ligating orthodontic bracket assembly of claim 1 wherein the retentive boss protrudes into the space between the legs of the pin and contacts the lower cross member in the open position.

5. The self-ligating orthodontic bracket assembly of claim 4 wherein the retentive boss further comprises lateral sides guiding the legs of the pin.

6. The self-ligating orthodontic bracket assembly of claim 4 wherein the retentive boss further comprises a curved surface for temporarily deforming the pin during initial assembly of the pin into the vertical slot of the bracket.

7. The self-ligating orthodontic bracket assembly of claim 1 wherein the intersection of the archwire slot and the vertical slot define corners, and wherein the camming surfaces on the legs contact the corners in the closed position.

8. The self-ligating orthodontic bracket assembly of claim 7 further comprising complementary camming surfaces on the corners contacting the camming surfaces on the legs of the pin in the closed position.

9. A self-ligating orthodontic bracket assembly comprising:
a bracket having:
(a) an archwire slot extending in a mesial-distal direction for receiving an archwire;
(b) a vertical slot extending into the bracket to intersect the archwire slot; and
(c) a retentive boss in the vertical slot; and
a pin for sliding engagement with the vertical slot between an open position and a closed position, said pin having:
(a) two parallel legs separated by a space, said legs extending across the archwire slot in the closed position to retain an archwire in the archwire slot, and retracting from the archwire slot in the open position to allow insertion of an archwire into the archwire slot, said legs having:
(i) a thin flex section allowing the leg to deflect laterally;
(ii) a wider retentive plate with a retentive projection extending laterally outward; and
(iii) an angled camming surface between flex section and retentive plate slidably engaging the vertical slot to hold the pin in the closed position; and
(b) a lower cross member extending between the legs, said lower cross member contacting the retentive boss in the open position to retain the pin in the vertical slot.

10. The self-ligating orthodontic bracket assembly of claim 9 further comprising an upper cross member extending between the legs to form a substantially rectangular pin.

11. The self-ligating orthodontic bracket assembly of claim 9 wherein the retentive boss protrudes into the space between the legs of the pin and contacts the lower cross member in the open position.

12. The self-ligating orthodontic bracket assembly of claim 11 wherein the retentive boss further comprises lateral sides guiding the legs of the pin.

13. The self-ligating orthodontic bracket assembly of claim 9 wherein the retentive boss further comprises a curved surface for temporarily deforming the pin during initial assembly of the pin into the vertical slot of the bracket.

14. The self-ligating orthodontic bracket assembly of claim 9 wherein the intersection of the archwire slot and the vertical slot define corners, and wherein the camming surfaces on the legs contact the corners in the closed position.

15. A self-ligating orthodontic bracket assembly comprising:
a bracket having:
(a) an archwire slot extending in a mesial-distal direction for receiving an archwire;
(b) a vertical slot extending into the bracket to intersect the archwire slot and define a plurality of corners;
(c) camming surfaces on the corners; and
(d) a retentive boss in the vertical slot; and
a pin for sliding engagement with the vertical slot between an open position and a closed position, said pin having:
(a) two parallel legs separated by a space, said legs extending across the archwire slot in the closed position to retain an archwire in the archwire slot, and retracting from the archwire slot in the open position to allow insertion of an archwire into the archwire slot;
(b) a lower cross member extending between the legs, said lower cross member contacting the retentive boss in the open position to retain the pin in the vertical slot; and
(c) camming surfaces on the legs slidably engaging the camming surfaces on the corners of the brackets to hold the pin in the closed position.

16. The self-ligating orthodontic bracket assembly of claim 15 wherein at least one of the legs comprises a thin flex section and a wider retentive plate with a retentive projection extending laterally outward from the pin.

17. The self-ligating orthodontic bracket assembly of claim 15 wherein the retentive boss protrudes into the space between the legs of the pin and contacts the lower cross member in the open position.

18. The self-ligating orthodontic bracket assembly of claim 17 wherein the retentive boss further comprises lateral sides guiding the legs of the pin.

19. The self-ligating orthodontic bracket assembly of claim 17 wherein the retentive boss further comprises a curved surface for temporarily deforming the pin during initial assembly of the pin into the vertical slot of the bracket.
